(19) United States
(12) Patent Application Publication
(10) Pub. No.: US 2023/0169448 A1
(43) Pub. Date: Jun. 1, 2023

(54) DELIVERY PREDICTION GENERATION SYSTEM

(71) Applicant: Walmart Apollo, LLC, Bentonville, AR (US)

(72) Inventors: Srinivasan Venkatesan, San Jose, CA (US); Sandeep Nayak, Bangalore (IN); Subhash Kumar Dhaka, Bengaluru (IN); Shantanu Rai, Bengaluru (IN); Balasubrahmanyam Chaturvedula, Bangalore (IN); Chandra Mohan Meena, Rajasthan (IN)

(21) Appl. No.: 18/160,261

(22) Filed: Jan. 26, 2023

Related U.S. Application Data
(63) Continuation of application No. 16/200,634, filed on Nov. 26, 2018, now abandoned.

(30) Foreign Application Priority Data
Oct. 13, 2018 (IN) 201841038924

(51) Int. Cl. G06Q 10/0833; G06N 5/046; G06N 7/01

(52) U.S. Cl. CPC G06Q 10/0833; G06N 5/046; G06N 7/01

(57) ABSTRACT

Examples provide on-time delivery prediction generation using a machine learning element for orders obtained from an order management component. The obtained order is analyzed to identify a plurality of order attributes. An initial value for each order attribute in the plurality of order attributes is calculated based on sensor data and telemetry data. An initial order-score for the obtained order is determined based on the initial values for each order attribute in the plurality of order attributes. An alternative order-score for the order is calculated after identifying an order attribute variable for the order and calculating updated values for each order attributes in the plurality of order attributes. After outputting the initial order-score and the alternative order-score for the order, with an indication of the order attribute variable associated with the alternative order-score, feedback for the order is received. A set of prediction criteria of the machine learning element is adjusted based on the feedback data.

### BACKGROUND

Whenever orders are placed by a customer requiring delivery of goods and/or services from a provider, both the customer and the provider prefer to receive an accurate prediction of the probability of on-time delivery. The customer often requires the goods or services to be delivered by a certain time and/or must be present to accept delivery. The provider depends on accurate prediction of the probability of on-time delivery to maintain a good reputation with customers and potential customers and thus sustain and grow revenue. Providers, especially those engaged in e-commerce, suffer from delays in order fulfillments due to multiple individual factors or a combination thereof. Failure to factor in such delays when predicting the probability of successful on-time delivery leads to inaccurate predictions, damaged provider reputation, and decreased revenue. With existing systems and methods, consistently predicting the pattern of likelihood of late delivery is commercially impracticable because the pattern comes from multiple factors; identifying these factors with conventional tools and methods is non-trivial. Contemporary order management systems merely aim to predict the time taken for the delivery to be completed based upon the average carrier performance.

### SUMMARY

Some examples provide a system for delivery prediction generation for virtual orders. The system includes at least one processor and a memory communicatively coupled to the at least one processor. The memory stores instructions that are operative when executed by the at least one processor. An order-score component stored on the memory and implemented by the at least one processor obtains an order from an order management component and analyzes the obtained order to identify a plurality of order attributes. The order-score component obtains sensor data corresponding to at least one identified order attribute in the plurality of order attributes. The order-score component determines an initial value for each order attribute in the plurality of order attributes based at least in part on the obtained sensor data and at least in part on telemetry data; calculates an initial order-score for the obtained order based on the determined initial values for each order attribute in the plurality of order attributes; and generates at least one order attribute variable for the obtained order. The order-score component calculates an updated value for the at least one order attribute variable and calculates an alternative order-score for the obtained order based on the determined initial values and the calculated updated value for the generated at least one order attribute variable. The order-score component outputs the initial order-score and the alternative order-score for the obtained order, with an indication of the at least one order attribute variable associated with the alternative order-score to the order management component.

Other examples provide a computer-implemented method for delivery prediction generation for virtual orders. An order-score component obtains an order from an order management component. The order-score component analyzes the obtained order to identify a plurality of order attributes; obtains sensor data corresponding to at least one identified order attribute in the plurality of order attributes; and determines an initial value for each order attribute in the plurality of order attributes based at least in part on the obtained sensor data and at least in part on telemetry data. The order-score component calculates an initial order-score for the obtained order based on the determined initial values for each order attribute in the plurality of order attributes. The order-score component generates at least one order attribute variable for the obtained order. The order-score component calculates an updated value for the at least one order attribute variable. The order-score component calculates an alternative order-score for the obtained order based on the determined initial values for each order attribute in the plurality of order attributes and the calculated updated value for the generated at least one order attribute variable. The order-score component outputs the initial order-score and the alternative order-score for the obtained order, with an indication of the at least one order attribute variable associated with the alternative order-score, to the order management component.

Still other examples provide one or more computer storage media, having computer-executable instructions for delivery prediction generation for virtual orders that, when executed by a computer having an at least one processor, cause the computer to perform operations. These operations comprise obtaining, by an order-score component implemented on the at least one processor of the computer, an order from an order management component; analyzing the obtained order to identify a plurality of order attributes; obtaining sensor data corresponding to at least one identified order attribute in the plurality of order attributes; determining an initial value for each order attribute in the plurality of order attributes based at least in part on the obtained sensor data and at least in part on telemetry data; and calculating an initial order-score for the obtained order based on the determined initial values for each order attribute in the plurality of order attributes. These operations further comprise generating at least one order attribute variable for the obtained order; calculating an updated value for the at least one order attribute variable; calculating an alternative order-score for the obtained order based on the determined initial values for each order attribute in the plurality of order attributes and the calculated updated value for the generated at least one order attribute variable; and outputting the initial order-score and the alternative order-score for the obtained order, with an indication of the at least one order attribute variable associated with the alternative order-score, to the order management component, the initial order-score and the alternative order-score being individual predictions of the probability of on-time delivery.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for delivery prediction generation.

FIG. 2 is an exemplary block diagram illustrating the possible content of a plurality of order attributes for an example order.

FIG. 3 is an exemplary flow chart illustrating operation of the computing device to perform delivery prediction generation.

FIG. 4 is an exemplary flow chart illustrating operation of the computing device to perform delivery prediction generation, based on iterating through each of a plurality of order attributes to compute and generate at least one order attribute variable.

FIG. 5 is an is an exemplary flow chart illustrating operation of the computing device to perform delivery prediction generation and modify the generated prediction based on an order change instruction received from an order management system.

FIG. 6 is an exemplary flow diagram illustrating an order fulfillment process incorporating delivery prediction generation.

FIG. 7 is an exemplary flow diagram illustrating the computation of an order-score by delivery prediction generation and the role of the order-score in the order fulfillment process.

FIG. 8 is an exemplary flow diagram illustrating an example embodiment for prediction generation in the ride sharing context.

FIG. 9 is an exemplary flow diagram illustrating an example embodiment for prediction generation in the e-commerce context.

FIG. 10 is an exemplary block diagram illustrating a machine learning component.

FIG. 11 is an exemplary block diagram illustrating an operating environment for a computing device implementing developer environment.

Corresponding reference characters indicate corresponding parts throughout the drawings.

### DETAILED DESCRIPTION

Referring to the figures, examples of the disclosure provide delivery prediction generation for virtual orders. Some examples of delivery prediction generation herein include machine learning (also referred to herein as “ML”) functionality. In some examples, delivery prediction generation operations are performed on orders obtained from an order management component (also referred to as an “OMC” or “order management system” herein). The orders contain a plurality of order attributes, such order attributes in some examples having corresponding sensor data, and the generated results of such operations are output to the order management system and/or output to various output devices, including but not limited to a user interface.

The elements described herein operate in an unconventional manner to allow for partial, complete, or near-complete automation of accurate on-time delivery probability prediction generation during a transaction between a provider of goods and/or services and a customer. The disclosure improves the functioning of the underlying computing device by, as a non-limiting example, using ML elements to: (1) identify patterns of common repeating outliers within order attributes which are known to decrease the probability of on-time delivery; and (2) instruct the order management component how to change the corresponding at least one order attribute to break the pattern and create the largest improvement in the probability of on-time delivery with the least cost. Unlike contemporary systems and methodologies, the disclosure herein allows for the commercially practicable, consistent prediction of the multiple-factor pattern of likelihood of on-time delivery via ML elements. The disclosure herein is thus not limited to merely predicting the time taken for completion of a delivery based upon the average carrier performance, as is the case with contemporary systems and methodologies. Rather, the disclosure herein generates, using multiple factors, a probability of on-time delivery according to the order attributes (and, optionally, the sensor data corresponding with such order attributes), as well as suggestions to the order management component for modifying the order attributes to raise that probability to an acceptable level. Additionally, such improved functionality allows for more efficient operations of the computing device, such that order delivery prediction generation tasks are completed using reduced bandwidth, reduced processing power, and reduced memory.

Examples of the disclosure are applicable to scenarios requiring accurate prediction of the correctness of estimated task competition times for a task—for example, whether the estimated probability of on-time delivery of goods and/or services purchased by customers from providers is accurate. These ML-powered predictions become ever more accurate over time as the ML system learns which of the past on-time delivery probability predictions of the ML system proved accurate, and why.

Order-Score Defined. The elements disclosed herein predict the probability of delivery of an order to be on-time or not (the “order-score”) before an order for goods and/or services is dispatched from the provider to the customer, by using ML to examine all factors of the order management system and the order known to be deterministic in predicting on-time delivery in real-time. In some examples, the factors of the order management system include supply chain data, such supply chain data being used to further refine the order-score. In some examples, the initial order-score and the alternative order-score are individual predictions of whether the order will be delivered on time. In some such examples, the initial order-score and the alternative order-score are each expressed as a number between zero (indicating an absolute certainty that the order fails to arrive on the target delivery date/time) and one (indicating an absolute certainty that the order arrives on target delivery date/time). In one example, an order-score of 0.5 indicates an equal likelihood of either on-time or late delivery. In other example, if the probability of an order to arrive on-time is below 0.1, then the order-score, with an accuracy of ninety-six-percent, indicates that the given order is going to arrive late. In yet other examples, the order-score is calculated after a customer makes a payment for an order and the order management system figures out the theoretically optimal way to dispatch the order on-time. The order-score thus indicates how likely the theoretically optimal delivery method is to actually facilitate on-time delivery. In some examples, the order-score is output to the order management system along with a suggestion of how to mitigate at least one delay-causing factor of the theoretical optimal delivery method. A compatible order management system uses that information to modify the at least one delay-causing factor to improve how the order is dispatched.

The order management system uses the order-score to react preemptively to mitigate delay factors on orders whose probability of being delayed surpasses a given threshold. The order management system uses the order-score to decrease the probability of delay and increase the probability of on-time delivery. Depending on the configuration of the elements herein, in some examples this ML-driven optimization occurs with all the speed advantages granted by partial or total automation.

Thus, both the customer and the provider receive more accurate predictions of the probability of completing delivery on-time. The customer is given confidence that predicted delivery arrival times are accurate enough to ensure the customer meets related deadlines and finds an easier experience scheduling presence for delivery acceptance. The provider has an improved experience maintaining a good reputation with customers and potential customers and sustaining and growing revenue. The elements disclosed herein consistently predict with ever-increasing accuracy the pattern of likelihood of late delivery applicable across all providers who deliver to customer addresses, especially providers engaged in e-commerce, by identifying and mitigating the underlying factors of the pattern in a way that is commercially practicable.

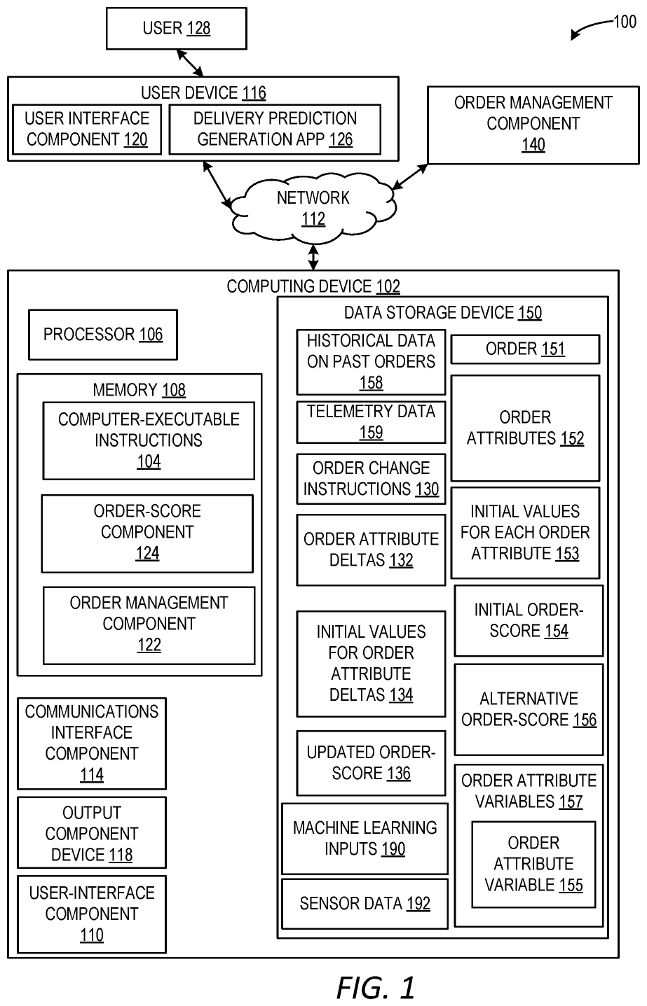

Referring again to FIG. 1, an exemplary block diagram illustrates a system 100 for delivery prediction generation. In the example of FIG. 1, a computing device 102 represents any device executing computer-executable instructions 104 (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, wearable device, and/or portable media player. The computing device 102 may also include less-portable devices such as servers, desktop personal computers, kiosks, or tabletop devices. Additionally, the computing device 102 may represent a group of processing units or other computing devices.

In some examples, the computing device 102 has at least one processor 106 and a memory 108. The computing device 102 may also include a user interface component 110.

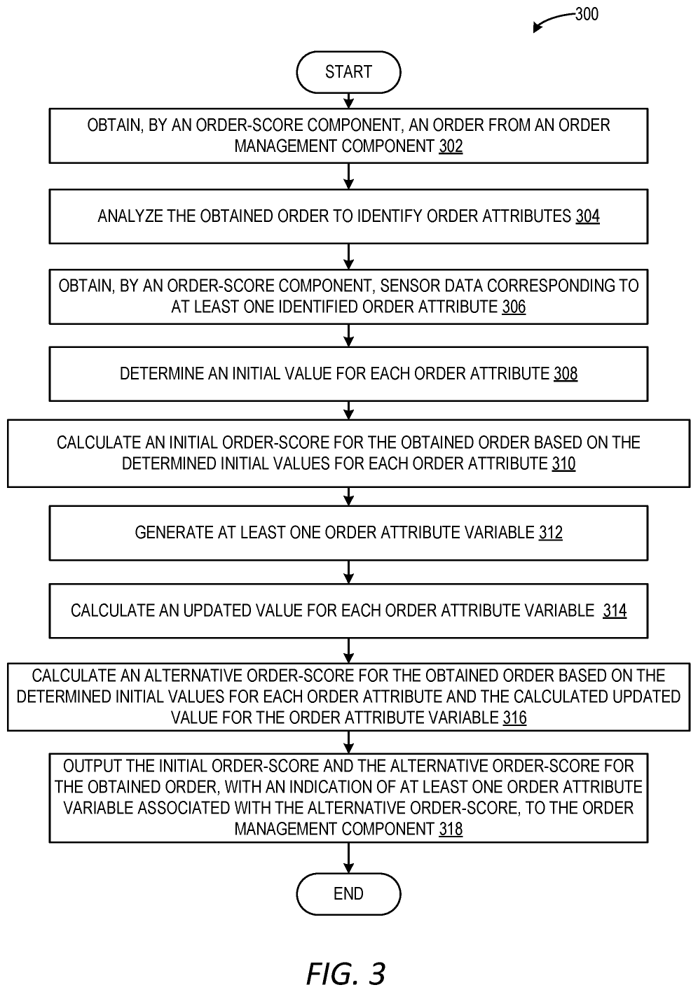

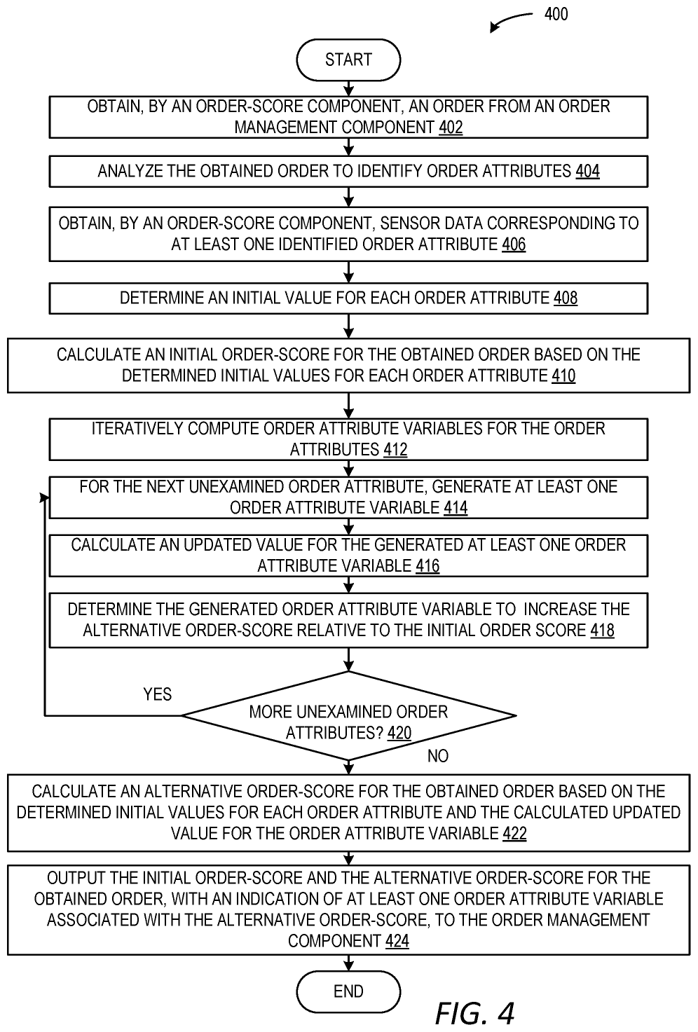

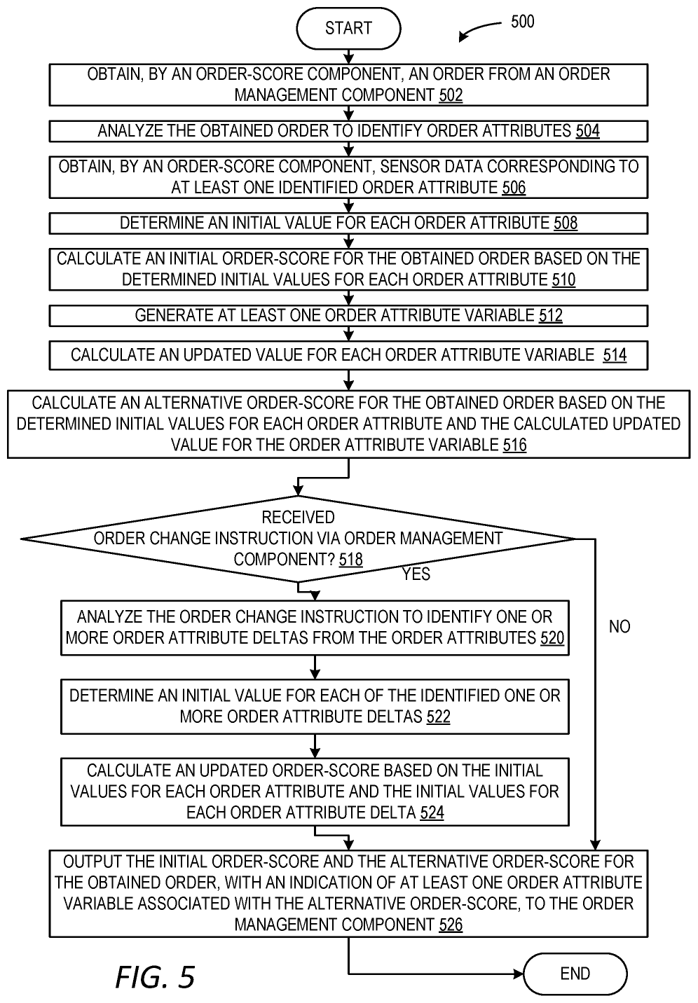

The at least one processor 106 includes any quantity of processing units and is programmed to execute the computer-executable instructions 104. The computer-executable instructions 104 may be performed by the at least one processor 106 or by multiple processors within the computing device 102 or performed by a processor external to the computing device 102. In some examples, the at least one processor 106 is programmed to execute instructions such as those illustrated in the figures (e.g., FIG. 3, FIG. 4, and FIG. 5).

The computing device 102 further has one or more computer readable media such as the memory 108. The memory 108 includes any quantity of media associated with or accessible by the computing device 102. The memory 108 may be internal to the computing device 102 (as shown in FIG. 1), external to the computing device 102 (not shown), or both (not shown). In some examples, the memory 108 includes read-only memory and/or memory wired into an analog computing device.

The memory 108 stores data, such as one or more applications. The applications, when executed by the at least one processor 106, operate to perform functionality on the computing device 102. The applications may communicate with counterpart applications or services such as web services accessible via a network 112. For example, the applications may represent downloaded client-side applications that correspond to server-side services executing in a cloud.

In other examples, the user interface component 110 includes a graphics card for displaying data to the user and receiving data from the user. The user interface component 110 may also include computer-executable instructions (e.g., a driver) for operating the graphics card. Further, the user interface component 110 may include a display (e.g., a touch screen display or natural user interface) and/or computer-executable instructions (e.g., a driver) for operating the display. The user interface component 110 may also include one or more of the following to provide data to the user or receive data from the user: a sound card, a camera, a microphone, a vibration motor, one or more accelerometers, a BLUETOOTH® brand communication module, global positioning system (GPS) hardware, and a photoreceptive light sensor. For example, the user may input commands or manipulate data by moving the computing device 102 in a particular way.

The network 112 is implemented by one or more physical network components, such as, but without limitation, routers, switches, network interface cards (NICs), and other network devices. The network 112 may be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a user device 116, may occur using any protocol or mechanism over any wired or wireless connection. In some examples, the communications interface component 114 is operable with short range communication technologies such as by using near-field communication (NFC) tags.

The user device 116 represents any device executing the computer-executable instructions 104 that is associated with a user 128. The user device 116 may be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 may also include a user interface component 120. In some examples, the user device 116 is a mobile computing device capable of communicating with the computing device 102 over the network 112 to facilitate delivery prediction generation.

An order management component 140 in some examples is one or more devices for generating and/or managing an order 151. In some examples, the order management component 140 is communicatively coupled to the network 112. In some examples, an order management component 122, which is functionally interchangeable with the order management component 140, is communicatively coupled directly to the computing device 102, without the network 112 being interposed between them. Unless otherwise stated, any description in this disclosure of the function of the order management component 140 applies equally to the order management component 122, and any description in this disclosure of the function of the order management component 122 applies equally to the order management component 140.

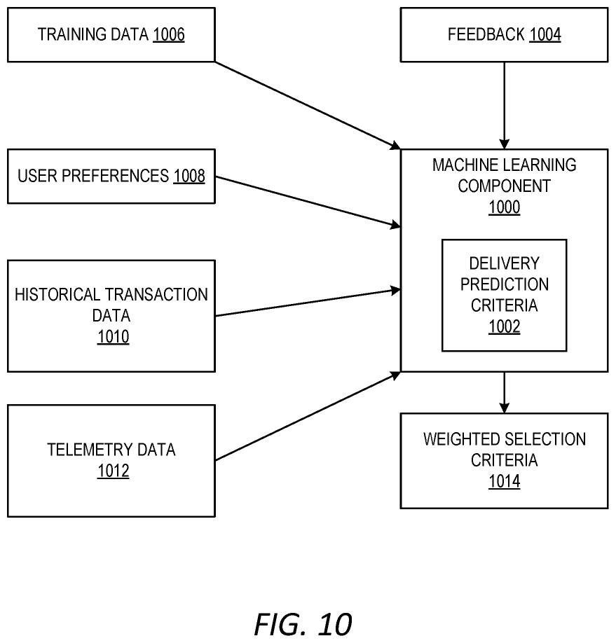

The system 100 may optionally include a data storage device 150 for storing data, such as, but not limited to: the plurality of orders 151; a plurality of order attributes 152; a plurality of initial values for each order attribute 153 in the plurality of order attributes 152; a plurality of initial order-scores 154; a plurality of order attribute variables 157 (containing at least one order attribute variable 155); a plurality of alternative order-scores 156; a plurality of historical data associated with past orders 158; a plurality of telemetry data 159 associated with past alternative order-scores 156 and generated order attribute variables 155; a plurality of order change instructions 130; a plurality of order attribute deltas 132; a plurality of initial values for each of the identified one or more order attribute deltas 134; a plurality of updated order-scores 136; a plurality of machine learning inputs 190; and sensor data 192. In some examples, the set of machine learning inputs 190 include, but are not limited to: training data, user preferences, historical transaction data, telemetry data, feedback, and a set of weighted selection criteria. The types and uses of the set of machine learning inputs 190 are discussed in further depth in the discussion of FIG. 10 herein.

The data storage device 150 in this example is included within the computing device 102 or associated with the computing device 102. In other examples, the data storage device 150 is a remote data storage accessed by the computing device 102 via the network 112, such as a remote data storage device, a data storage in a remote data center, or a cloud storage service.

The data storage device 150 in some non-limiting examples is utilized to aggregate data together for delivery prediction generation. In some examples, the aggregated data includes but is not limited to: the plurality of orders 151; the plurality of order attributes 152; the plurality of initial values for each order attribute 153 in the plurality of order attributes 152; the plurality of initial order-scores 154; the plurality 157 of the at least one order attribute variables 155; the plurality of alternative order-scores 156; the plurality of historical data associated with past orders 158; the plurality of telemetry data 159 associated with past alternative order-scores 156 and generated order attribute variables 155; the plurality of order change instructions 130; the plurality of order attribute deltas 132; the plurality of initial values for each of the identified one or more order attribute deltas 134; the plurality of updated order-scores 136; the plurality of machine learning inputs 190, the sensor data 192; etc. This enables data utilized for delivery prediction generation to be aggregated into a single location for quick and efficient access by an order-score component 124 and/or a delivery prediction generation application on the user device 116. In other examples, such data is aggregated on a cloud storage device rather than a physical data storage associated with the computing device 102.

The memory 108 in some examples stores one or more computer-executable components. Exemplary components include but are not limited to the order management component 122 and the order-score component 124. In other examples, the memory 108 does not store the order management component 140, but rather the order management component 140 is, for example, any computing device, mobile device, dedicated hardware, or other component capable of functioning to manage orders as described herein.

The order-score component 124 obtains the order 151 from the order management component 122. The order-score component 124 further analyzes the obtained order 151 to identify the plurality of order attributes 152 and obtains sensor data 192 corresponding to at least one identified order attribute 152 in the plurality of order attributes. 152. Sensor data 192 is any data collected by any means regarding relevant ongoing and/or real-time real-world conditions. Relevant conditions are those that, under certain circumstances, may influence the values of the identified order attributes 152. For example, without limitation, sensor data may include weather data, temperature data, capacity data, transportation data, location data, and/or any other suitable data about real-world conditions.

The order-score component 124 determines the initial value for each order attribute 153 in the plurality of order attributes 152 based at least in part on the obtained sensor data 192 and at least in part on telemetry data 159. Without limitation, the telemetry data 159 includes but is not limited to past data generated and or calculated by the order-score component 124 and/or the order management component 122. The telemetry data 159 also includes but is not limited to feedback data, such as whether the data generated about past orders 151 was: accurate, accepted, rejected, or modified by the order management component 122; was used to further refine the ML-powered prediction model used to calculate initial order-scores 154 and alternative order-scores 156; and other such similar efficacy metrics. In some examples, telemetry data 159 is used in combination with the sensor data 192 to weight the determination of the initial values for each order attribute 153 to ensure the order-score component 124 determines the initial value of each of the order attributes 153 such that known data about past orders and current conditions is considered by the order-score component 124 in calculating order-scores.

In some examples, the plurality of order attributes 152 are a collection of individual data points about the order 151 that, when taken as a whole, describe all the details of the order 151 to the order management component 122 which are necessary to enable the order management component 122 to perform its designated functions. In some such examples, the plurality of order attributes 152 for the order 151 includes, without limitation, at least one of a postal code of a delivery address, a weight of at least one item of the order, a height of at least one item of the order, a length of at least one item of the order, a width of at least one item of the order, a quantity of items associated with the order, an associated distribution center value for the order, an associated fulfillment center value for the order, a time in transit value for the order, a customer type, a delivery address type, a date of order placement for the order, a time of order placement for the order, an expected shipping date for the order, or a carrier selection associated with the order.

In such examples, sensor data 192 includes, without limitation and to the extent such information bears on accurate on-time delivery prediction generation, weather data for the postal code of the delivery address, information on any delays at the associated distribution center and/or fulfillment center, information on any known relevant delays being experienced by the selected carrier, infrastructure issues (e.g.: power outages, natural disasters, mass vehicle accidents, etc.) impacting the physical movement of order items, calendar data (e.g.: federal holidays and other events during which certain carriers suspend operations), etc.

Once this analysis is complete, the order-score component 124 further calculates the initial order-score 154 for the obtained order 151 based on the determined initial values for each order attribute 153 in the plurality of order attributes 152; generates the at least one order attribute variable 155 for the obtained order 151; and calculates an updated value for the at least one order attribute variable 155. Each of the at least one order attribute variables 155 in the plurality of order attribute variables 157 corresponds to one of each of the order attributes 152 in the order 151 and contains a generated new value for the corresponding order attribute 152. The order-score component 124 generates each of the at least one order attribute variables 155 in the plurality of order attribute variables 157 with the goal that replacing the initial value for the corresponding order attribute 153 with the value of the corresponding at least one order attribute variable 155 results in the alternative order-score 156 indicating a higher probability of on-time delivery than the initial order-score 154.

The order-score component 124 calculates the alternative order-score 156 for the obtained order 151 based on the determined initial values 153 and the calculated updated value for the generated at least one order attribute variable 155. In some examples, to calculate the alternative order-score 156, the order-score component 124 utilizes the generated at least one order attribute variable 155 determined to result in the most improved alternative order-score 156 in comparison to the initial order-score 154. In such examples, the generated at least one order attribute variable 155 is either the single order attribute variable 155 or multiple order attribute variables 155.

In some examples, when generating the at least one order attribute variable 155, the order-score component 124 further iteratively computes a plurality of order attribute variables 157 for the plurality of order attributes 152 to generate the at least one order attribute variable 155. In such examples, the generated at least one order attribute variable 155 is determined to increase the alternative order-score relative to the initial order-score—that is, the order-score component generates only the at least one order attribute variable 155 that, if used by the order management component 122 to modify the plurality of order attributes 152 of the order 151, results in the alternative order-score 156 (the alternative probability of on-time delivery) being greater than the initial order-score 154 (the initial probability of on-time delivery). In other words, the order-score component 124 guards against inadvertently decreasing the probability of on-time delivery.

In some examples wherein the order-score component 124 further iteratively computes a plurality of order attribute variables 157 for the plurality of order attributes 152 to generate the at least one order attribute variable 155, the order-score component iteratively computes the plurality of order attribute variables based at least in part on historical data associated with past orders 158 and/or at least in part on telemetry data 159 associated with past alternative order-scores 156 and generated order attribute variables 157.

In some such examples, historical data 158 refers to the history of past orders 151. Thus, the historical data 158 includes the plurality of order attributes 152 for each of the at least one past orders 151, as well as information on whether or not each of the at least one past orders 151 was delivered on time. The order-score component 124, while engaged in iteratively computing the plurality of order attribute variables 157 for the plurality of order attributes 152 to generate the at least one order attribute variable 155, utilizes the historical data 158 to compute each of the at least one order attribute variables 155 in the plurality of order attribute variables 157 with a higher degree of confidence, because the machine learning elements of the order-score component 124 are able to learn from the historical data 158 what order attributes 152 and attribute variables 155 most contributed to calculating an improved alternative order-score 156 to achieve a theoretical higher probability of on-time delivery. The order-score component 124 accordingly optimizes the computation of the at least order attribute variable 155 in the plurality of order attribute variables 157 for the present order 151.

The historical data 158 provides information about initial inputs and final outcomes of the past orders 151 to the order-score component 124. The historical data 158 answers the question of what the order-score component 124 predicted the end result—the probability of on-time delivery—to be, given a specific set of inputs (e.g.: order attributes). The telemetry data 159, by contrast, allows for a more in-depth analysis by the machine learning elements of the disclosure as to the accuracy of the generated prediction embodied in the alternative order-score 156 and the at least one order attribute variable 155 for each of the past orders 151; how that prediction was either utilized, modified, or rejected by the order management component 122; and/or how that prediction was used to further refine the ML-powered prediction model used to calculate the initial order-scores 154 and alternative order-scores 156, or some combination thereof.

Thus, the order-score component 124, while engaged in iteratively computing the plurality of order attribute variables 157 for the plurality of order attributes 152 to generate the at least one order attribute variable 155, utilizes the telemetry data 159 in computing each of the at least one order attribute variables 155 in the plurality of order attribute variables 157 to weight one or more of the attributes, or provide a confidence value, because the machine learning elements of the order-score component 124 are able to determine from the telemetry data 159 the accuracy of alternative order-scores 156 generated for past orders 151, as well as whether and how such order-scores were utilized and/or modified by the order management component 122. The order-score component 124 accordingly optimizes the computation of the at least order attribute variable 155 in the plurality of order attribute variables 157 for the present order 151. In some examples, the order-score component 124 also further optimizes the ML-powered prediction model used to calculate the initial order-scores 154 and alternative order-scores 156.

Examples of the disclosure are configurable to use either the historical data 158, the telemetry data 159, or some combination of at least part of both the historical data 158 and the telemetry data 159 as described above. The decision on which combination to use in a particular example depends on the needs of and resources available to a particular application.

The historical data 158 and telemetry data 159 grows in volume with every order 151 obtained by the order-score component 124 from the order management component 122. Thus, every time the order-score component 124 uses the historical data 158 and/or the telemetry data 159 as described above, the accuracy of the prediction embodied in the resulting alternative order-score 156 is either improved over the alternative order-scores 156 that the order-score component 124 outputted in the past, or at least as good as the alternative order-scores 156 the order-score component 124 outputted in the past. This continuous feedback loop ensures that the accuracy of generated delivery predictions from examples of the disclosure which incorporate the historical data 158 and the telemetry data 159 improves over time.

The order-score component 124 further outputs the initial order-score 154 and the alternative order-score 156 for the obtained order 151, with an indication of the at least one order attribute variable 155 associated with the alternative order-score 156, to the order management component 122. In some examples, upon receipt of the initial order-score 154, the alternative order-score 156, and the indication of the at least one order attribute variable 155, the order management component 122 determines whether the benefit indicated by the increased probability of on-time delivery reflected in the alternative order-score 156 is worth the increased cost reflected in the modification to the order 151 suggested by the indication of the at least one order attribute variable 155, such at least one order attribute variable 155 having been chosen by the order-score component 124 as a mitigating factor.

For example, assume the existence of the hypothetical order 151, which the order-score component 124 obtains from the order management component 122 and operates upon as described above. The order-score component 124 calculates the initial order-score 154 as 0.65. That is, there is a sixty-five-percent chance the theoretical order 151, if unmodified by the order management component 122, arrives on time. Operating as described above, the order-score component 124 outputs the initial order-score 154 back to the order management component 122 along with the hypothetical alternative order-score of 0.85 and an indication of the at least one order attribute variable 155 which the order management component 122 needs to alter within the order 151 to achieve the alternative order-score 156 such that the probability of on-time delivery rises to the predicted eighty-five-percent—a positive mitigation of a twenty-percent increase in the probability of on-time delivery.

In this hypothetical example, the order management component 122 performs a cost-benefit analysis to determine if the increased probability of on-time delivery is worth the monetary cost associated with altering the order 151 as recommended by the order-score component 124. In some such examples, the methodology of the cost-benefit analysis, as well as the comparative weights of the various costs and benefits, are customizable by the provider of goods and/or services in order to meet their sales goals and needs and reflect their available resources.

If, for example, the at least one order attribute variable 155 output by the order-score component 124 indicated that changing carriers achieves the described twenty-percent increase in the probability of on-time delivery, and the order management component 122 determined the increased cost of such a change was nominal, such as for example only $0.20, the cost-benefit analysis performed by the order management component 122 may be configured to implement such a change. In a contrasting example, if the at least one order attribute variable output by the order-score component 124 indicated that changing carriers would achieve the described twenty-percent increase in the probability of on-time delivery, and the order management component 122 determined the increased cost of such a change was over a threshold amount, such as for example $5.00, the cost-benefit analysis performed by the order management component 122 may be configured to reject such a change as being cost-prohibitive.

In some examples, the order-score component 124 is further implemented to receive the order change instruction 130 for the order 151 from the order management component 122. The order management component 122 sends the order change instruction 130 to the order-score component 124 when necessary to update a value of the at least one order attribute 152. The order management component 122 takes such action in some examples when the user 128 modifies the order 151 after having placed the order 151.

In such examples, the order-score component 124 analyzes the order change instruction 130 to identify the one or more order attribute deltas 132 from the plurality of order attributes 152 and determines the initial value for each of the identified one or more order attribute deltas 134. The initial value for each of the identified one or more order attribute deltas 134 contains an updated value for the corresponding order attribute 152 or, in in another example, the difference between the present value of the corresponding order attribute 152 and the new value of the corresponding order attribute 152. In the former example, the order-score component 124 replaces the corresponding order attribute 152 value with the initial value for each of the one or more order attribute deltas 134, and in the latter example the order-score component uses the initial value for each of the one or more order attribute deltas 134 to determine an updated value for each of the corresponding order attributes 152. The order-score component 124 calculates the updated order-score 136 for the obtained order 151 based on the determined initial values for each order attribute 153 in the plurality of order attributes 152 and the initial values for each of the identified one or more order attribute deltas 134. The updated order-score 136 replaces the alternative order-score 156 in the order management component 122.

In some such examples, the order change instruction 130 is received after the alternative order-score 156 is calculated by the order-score component 124, but before the alternative order-score 156 is output by the order-score component 124 to the order management component 122. In other such examples, the order change instruction 130 is alternatively received only after the alternative order-score 156 is output by the order-score component 124 to the order management component 122. In either scenario, the updated order-score 136 is calculated as described above and output to the order management component 122.

In some examples, the order-score component 124 requests and obtains sensor data 192 in response to receiving the order change instruction 130 for the order 151 from the order management component 122. The initial value for each of the identified one or more order attribute deltas 134 is determined at least in part based on the sensor data 192. In such examples, the sensor data 192 contains information relevant to the order attribute deltas 134. In one such example, if the change instruction 130 directs the carrier to use a specific vehicle type, obtaining sensor data 192 on the order item storage capacity of the new vehicle type provides significantly useful information in predicting if the order will be delivered on time. Specifically, if the new vehicle type has limited order item storage capacity and orders must be broken out into multiple deliveries, the probability of on-time delivery drops.

In some examples, the computing device 102 further includes or is communicatively coupled with an output component device 118. In some examples, the output component device 118 is the user interface component 110 of the computing device 102. In some examples, the output component device 118 outputs the initial order-score 154 and the alternative order-score 156 with an indication of the at least one order attribute variable 155, and/or the updated order-score 136. In some examples, this output is a three-dimensional or two-dimensional image including real-world elements as well as virtual/graphical elements generated by the output component device 118.

In other examples, the computing device 102 sends output to the user device 116 via the network 112. The delivery prediction generation application 126 generates the output to be displayed on the user device 116, which in some examples is a three-dimensional or two-dimensional image including real-world elements as well as virtual/graphical elements, based on the data received by the user device 116 from the computing device 102 via the network 112. The user interface component 120 on the user device 116 utilizes the output received from the computing device 102 to generate output displayed to the user 128. In some examples, the user device 116 downloads the delivery prediction generation application 126 from a web applications server via the network 112.

The computing device 102 performs delivery prediction generation using the order 151 obtained from the order management component 122 and/or the order management component 140. The user device 116 in some examples communicates with the computing device 102 or other local server on the Internet via web services application programming interface (API) management.

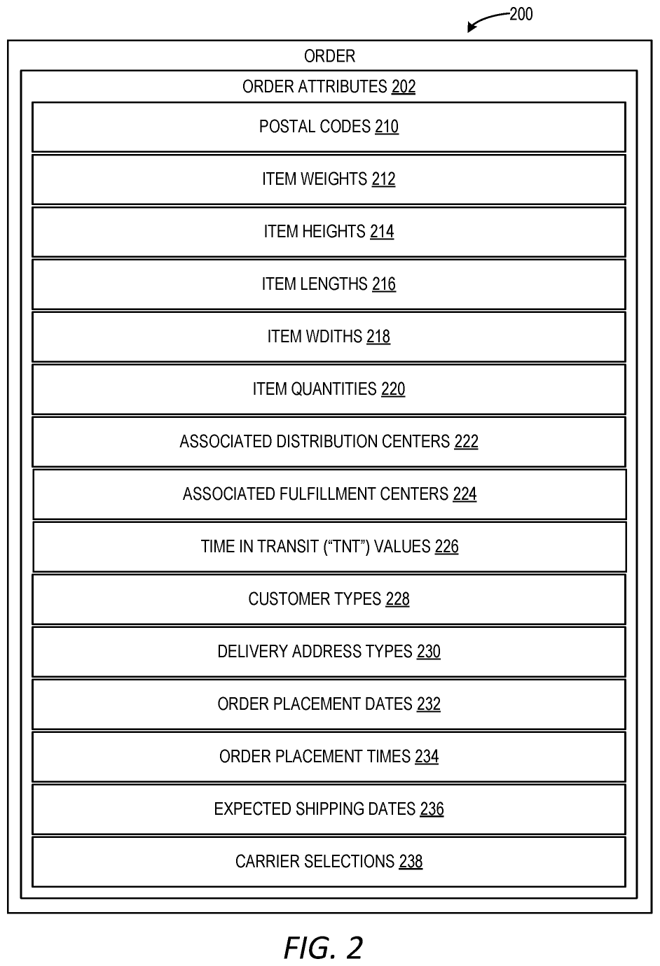

FIG. 2 is an exemplary block diagram illustrating the possible content of a plurality of order attributes for an example order 200. In some examples, the order 200 is the order 151 of FIG. 1. FIG. 2 depicts the order 200 as dispatched from an order management component (e.g.: the order management component 122 of FIG. 1) to an order-score component (e.g.: the order-score component 124 of FIG. 1). In some examples, the order 200 contains a plurality of order attributes 202 (e.g.: the plurality of order attributes 152 of FIG. 1). In some such examples, the plurality of order attributes 202 includes, but is not limited to, at least one of:
a postal code of a delivery address 210;
a weight of at least one item of the order 212;
a height of at least one item of the order 214;
a length of at least one item of the order 216;
a width of at least one item of the order 218;
a quantity of items associated with the order 220;
an associated distribution center value for the order 222;
an associated fulfillment center value for the order 224;
a time in transit (“TNT”) value for the order 226;
a customer type 228 (e.g.: business, individual, government, etc.);
a delivery address type 230 (e.g.: commercial, residential, PO box, etc.);
a date of order placement for the order 232;
a time of order placement for the order 234;
an expected shipping date for the order 236; and/or
a carrier selection associated with the order 238.

In some examples, the associated distribution center value for the order 222 refers to a physical location (a distribution center) where goods are warehoused. These warehoused goods are used by providers to complete the orders 151. A network of distribution centers connected by roads, railways, nautical and aeronautical routes, and other various means of shipping physical goods enables a provider to establish a system for storing goods and delivering them to customers.

In some examples, the associated fulfillment center value for the order 224 refers to a physical location (a fulfilment center). In some such examples, fulfilment centers are specialized distribution centers optimized to deliver goods and/or services via e-commerce.

In some examples, the order management component initially chooses the associated distribution center value for the order 222 by selecting for the lowest delivery cost. In some examples, the order-score component indicates a change that increases the order-score but raises the delivery cost (e.g., by indicating a different, more expensive associated distribution center value for the order 222).

The TNT value for the order 226 is the time required for an order 200 to be transported from a point of origin to a destination. In some examples, each distribution center has a fixed TNT value for the order 226. In such examples, depending on the associated distribution center value for the order 222, the order management system uses the TNT to calculate the transit time of an item from point A (e.g.: the distribution center) to point B (e.g.: the delivery address of the customer or some intermediate stop on the journey to the delivery address of the customer). In some examples, by combining the TNT value for the order 226 for each of the associated distribution center value for the order 222, the order management component determines the estimated total time to delivery an item.

In some other examples, the order 200 may include only a subset of the plurality of order attributes 202 depicted in FIG. 2, or additional order attributes 202 not listed or depicted in FIG. 2.

FIG. 3 is an exemplary flow chart illustrating operation of the computing device to perform delivery prediction generation. In some examples, the process shown in FIG. 3 is performed by an order-score component and an order management component, executing on a computing device, such as the computing device 102, the order management component 122, the order-score component 124, and/or the user device 116 in FIG. 1.

The process begins by obtaining an order from an order management component at operation 302. An order-score component implemented on at least one processor obtains the order. In some examples, the order management component is one or more devices for generating and/or managing the order. The order-score component analyzes the obtained order to identify a plurality of order attributes at operation 304. In some examples, the plurality of order attributes includes at least one of a postal code of a delivery address, a weight of at least one item of the order, a height of at least one item of the order, a length of at least one item of the order, a width of at least one item of the order, a quantity of items associated with the order, an associated distribution center value for the order, an associated fulfillment center value for the order, a time in transit value for the order, a customer type, a delivery address type, a date of order placement for the order, a time of order placement for the order, an expected shipping date for the order, a carrier selection associated with the order, or any other suitable attribute. In some examples, the plurality of order attributes may be the plurality of order attributes 152 in FIG. 1 or the plurality of order attributes 202 in FIG. 2. The order-score component obtains sensor data corresponding to at least one identified order attribute in the plurality of order attributes at operation 306. In some examples, sensor data may be the sensor data 192 in FIG. 1. The order-score component determines an initial value for each order attribute in the plurality of order attributes based at least in part on the obtained sensor data and at least in part on telemetry data at operation 308. The telemetry data and sensor data are used similarly to how the telemetry data and sensor data is used in FIG. 1. In some examples, the telemetry data is the telemetry data 159 in FIG. 1 and sensor data is the sensor data 192 in FIG. 1.

The process calculates an initial order-score for the obtained order based on the determined initial values for each order attribute in the plurality of order attributes at operation 310. The calculated initial order-score represents the probability of on-time delivery using the unmodified plurality of order attributes obtained from the order management component. The order-score component generates at least one order attribute variable for the obtained order at operation 312 and calculates an updated value for the at least one order attribute variable at operation 314. Each of the at least one order attribute variables in the plurality of order attribute variables corresponds to one of each of the order attributes in the order and contains a generated new value for the corresponding order attribute, with the goal that replacing the initial value for the corresponding order attribute with the value of the corresponding at least one order attribute variable results in a new order-score indicating a higher probability of on-time delivery than the initial order-score. The order-score component calculates an alternative order-score for the obtained order based on the determined initial values for each order attribute in the plurality of order attributes and the calculated updated value for the generated at least one order attribute variable at operation 316; and outputs the initial order-score and the alternative order-score for the obtained order, with an indication of the at least one order attribute variable associated with the alternative order-score, to the order management component at operation 318. The process terminates thereafter.

In some examples, the initial order-score and the alternative order-score are individual predictions of whether the order will be delivered on time.

In some examples, upon receipt of the initial order-score, the alternative order-score, and the indication of the at least one order attribute variable, the order management component determines whether the benefit indicated by the increased probability of on-time delivery reflected in the alternative order-score is worth the increased cost reflected in the modification to the order suggested by the indication of the at least one order attribute variable, such at least one order attribute variable having been chosen by the order-score component as a mitigating factor.

While the operations illustrated in FIG. 3 are performed by a computing device, aspects of the disclosure contemplate performance of the operations by other entities. In some examples, a cloud service performs one or more of the operations.

FIG. 4 is an exemplary flow chart illustrating operation of the computing device to perform delivery prediction generation, based on iterating through each of a plurality of order attributes to compute and generate at least one order attribute variable. In some examples, the process shown in FIG. 4 is performed by an order-score component and an order management component, executing on a computing device, such as the computing device 102, the order management component 122, the order-score component 124, and/or the user device 116 in FIG. 1. Operations 402, 404, 406, 408, and 410 of the process depicted in FIG. 4 are similar to operations 302, 304, 306, 308, and 310 of the process depicted in FIG. 3.

In some examples, the order-score component iteratively computes a plurality of order attribute variables for the plurality of order attributes to generate the at least one order attribute variable, the generated at least one order attribute variable determined to increase the alternative order-score relative to the initial order-score, at operation 412.

To complete operation 412, for the next unexamined order attribute in the plurality of order attributes, the order-score component computes and generates the at least one order attribute variable at operation 414 and calculates an updated value for the generated at least one order attribute variable at operation 416. The order-score component determines the generated order attribute variable to increase the alternative order-score relative to the initial order-score at operation 418. The order-score component determines if there are more unexamined order attributes in the plurality of order attributes at operation

If there are more unexamined order attributes in the plurality of order attributes, the process repeats from operation 414.

If there are not more unexamined order attributes in the plurality of order attributes, the order-score component continues to operation 422. Operations 422 and 424 of the process depicted in FIG. 4 are similar to operations 316 and 318 of the process depicted in FIG. 3. The process terminates thereafter. In some examples of the process depicted in FIG. 4, the order-score component is further implemented on the at least one processor to iteratively compute the plurality of order attribute variables based at least in part on historical data associated with past orders. In other examples of the process depicted in FIG. 4, the order-score component is further implemented on the at least one processor to iteratively compute the plurality of order attribute variables based at least in part on telemetry data associated with past alternative order-scores and generated order attribute variables. The benefits of utilizing the historical data and the telemetry data are explored in depth in the discussion of FIG. 1 herein.

While the operations illustrated in FIG. 4 are performed by a computing device, aspects of the disclosure contemplate performance of the operations by other entities. In some examples, a cloud service performs one or more of the operations.

FIG. 5 is an is an exemplary flow chart illustrating operation of the computing device to perform delivery prediction generation and modify the generated prediction based on an order change instruction received from an order management system. In some examples, the process shown in FIG. 5 is performed by an order-score component and an order management component, executing on a computing device, such as the computing device 102, the order management component 122, the order-score component 124, and/or the user device 116 in FIG. 1. Operations 502, 504, 506, 408, 510, 512, 514, and 516 of the process depicted in FIG. 5 are similar to operations 302, 304, 306, 308, 310, 312, 314, and 316 of the process depicted in FIG. 3.

In some examples of the process depicted in FIG. 5, the order-score component is further implemented on the at least one processor to determine whether an order change instruction for the order is received from the order management component at operation 518. The order management component sends the order change instruction to the order-score component, which may trigger the order-score component to recalculate and update a value of at least one order attribute. The order management component takes such action in some examples when the user modifies the order after having placed the order.

If the order-score component receives the order change instruction at operation 518, then the order-score component analyzes the order change instruction to identify one or more order attribute deltas from the plurality of order attributes at operation 520. The order-score component determines an initial value for each of the identified one or more order attribute deltas at operation 522.

The initial value for each of the identified one or more order attribute deltas contains an updated value for the corresponding order attribute or, in the alternative, the difference between the present value of the corresponding order attribute and the new value of the corresponding order attribute. In the former case, the order-score component replaces the corresponding order attribute value with the initial value for each of the one or more order attribute deltas, and in the latter case the order-score component uses the initial value for each of the one or more order attribute deltas to determine an updated value for each of the corresponding order attributes.

The order-score component calculates an updated order-score for the obtained order based on the determined initial values for each order attribute in the plurality of order attributes and the initial values for each of the identified one or more order attribute deltas at operation 524.

After completing operation 524, or if no order change instruction was received for the order from the order management component at 518, the order-score component outputs the initial order-score and the alternative order-score for the obtained order, with an indication of the at least one order attribute variable associated with the alternative order-score, to the order management component at operation 526.The process terminates thereafter.

In some such examples of the process depicted in FIG. 5, the order change instruction is received after the alternative order-score is calculated by the order-score component at operation 516, but before the alternative order-score is output by the order-score component to the order management component at operation 526. In other such examples, the order change instruction is alternatively received only after the alternative order-score is output by the order-score component to the order management component at operation 526. In either scenario, the updated order-score is calculated and output to the order management component as described above.

In some examples, the order-score component requests and obtains sensor data in response to receiving the order change instruction for the order from the order management component. The initial value for each of the identified one or more order attribute deltas is determined at least in part based on the sensor data. In such examples, the sensor data contains information relevant to the order attribute deltas. In one such example, if the change instruction 130 directs the carrier to use two-day delivery, obtaining sensor data 192 on the carriers suited to provide such service provides significantly useful information in predicting if the order will be delivered on time. Specifically, if the sensor data indicates that the cheapest suitable carrier is experiencing significant delays delivering to the postal code of customer due to a systems failure, the probability of on-time delivery decreases, and the order-score component chooses a different suitable carrier.

While the operations illustrated in FIG. 5 are performed by a computing device, aspects of the disclosure contemplate performance of the operations by other entities. In some examples, a cloud service performs one or more of the operations.

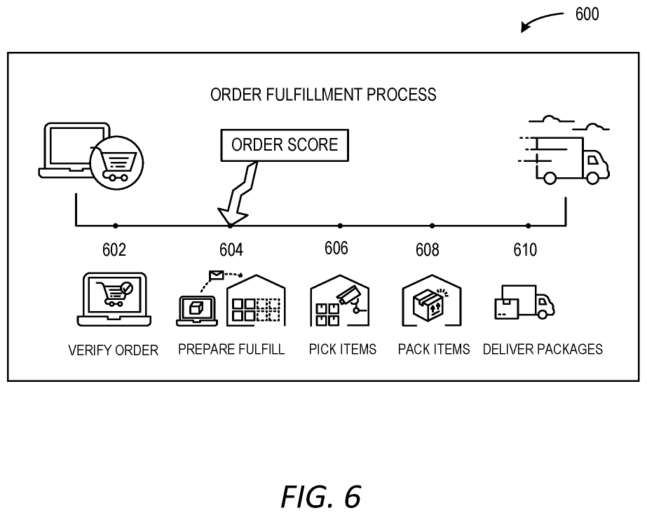

FIG. 6 is an exemplary flow diagram 600 illustrating an order fulfillment process incorporating delivery prediction generation. In some examples, the process shown in FIG. 6 is performed by an order-score component and an order management component, executing on a computing device, such as the computing device 102, the order management component 122, the order-score component 124, and/or the user device 116 in FIG. 1. The process begins by verifying, via the order management component an order (e.g.: the order 151 of FIG. 1) placed by user at 602 via e-commerce, using, in some examples, the user device 116 of FIG. 1.

The order management component prepares to fulfill the order at 604. At this point, the order-score component is activated to obtain the order from the order management component and generate an initial order-score representing a prediction of on-time delivery based on the plurality of order attributes stored by the order management system, and an alternative order-score based on the plurality of order attributes as modified by the at least one order attribute variable generated by the order-score component to improve the initial order-score and increase the likelihood of on-time delivery. The order management component analyzes the initial order-score, the alternative order-score, and the at least one order attribute variable to determine whether the order attributes of the order should actually be changed and make any such changes.

The goods and/or services necessary to complete the order are picked at 606, packed at 608, and delivered at 610. Delivery is conducted according to the order attributes set by the order management component working in concert with the order-score component as described herein. After delivery is complete, the process terminates.

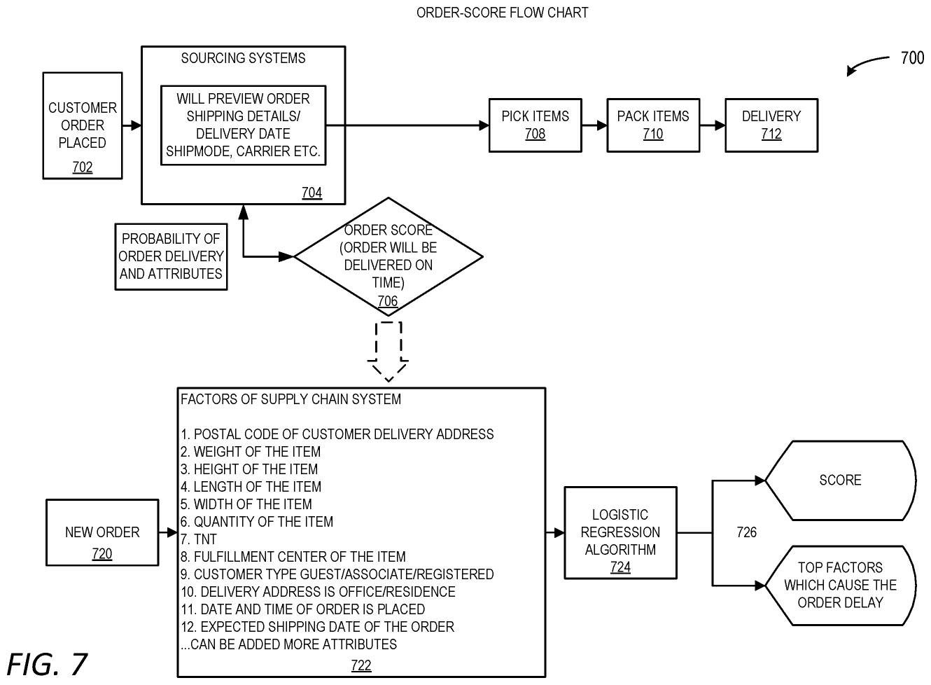

FIG. 7 is an exemplary flow diagram 700 illustrating the computation of an order-score by delivery prediction generation and the role of the order-score in the order fulfillment process. In some examples, the process shown in FIG. 6 is performed by an order-score component and an order management component, executing on a computing device, such as the computing device 102, the order management component 122, the order-score component 124, and/or the user device 116 in FIG. 1. The process begins when a customer places an order at 702. In some examples, the order is placed via e-commerce, while in other examples the order is placed by one of a telephone, mail order system, facsimile (fax) order system, or some other communications medium suitable for transmission of orders by customers to providers.

Sourcing systems used by the provider (e.g.: the order management component) provide order shipping details at 704. Such order shipping details, in some examples, include but are not limited to the order attributes 202 of the order 200 of FIG. 2 and/or the plurality of order attributes 152 of the plurality of orders 151 of FIG. 1. The initial order-score and alternative order-score, as well as the at least one order attribute variable, are generated as described elsewhere herein and output to the sourcing systems at 706. In some examples, if the sourcing systems receive any order change instructions during any phase of this process, the sourcing systems request an updated initial order-score and an updated alternative order-score. The goods and/or services necessary to complete the order are picked at 708, packed at 710, and delivered at 712. Delivery is conducted according to the order attributes set by the order management component working in concert with the order-score component as described herein. After delivery is complete, the process terminates. If the sourcing systems detect any determinative order changes during operations 708, 710, or 712 prior to the delivery of the order to the customer, the sourcing systems optionally repeat operation 706 as described above before continuing the process. After delivery is complete, the process suspends.

A new order is placed at 720. The sourcing systems provide order shipping details at 722, just as was done for the prior order at 702. The initial order-score and alternative order-score, as well as the at least one order attribute variable, are generated as described elsewhere herein and output to the sourcing systems at 726. In some examples, a logistic regression algorithm 724 is applied to the order shipping details during the generation of the initial order-score and alternative order-score, as well as the at least one order attribute variable, such that the machine learning elements of the disclosure learn in real-time from the at least one prior order and deliver for the new order a resulting initial order-score, alternative order-score, and at least one order attribute variable that represents an increase in the probability of on-time delivery for the new order that is at least as good or better than the increase provided for the at least one prior order.

After such generation, the new order is further processed as described in operations 708, 710, and 712 above, and the process suspends until another new order is received.

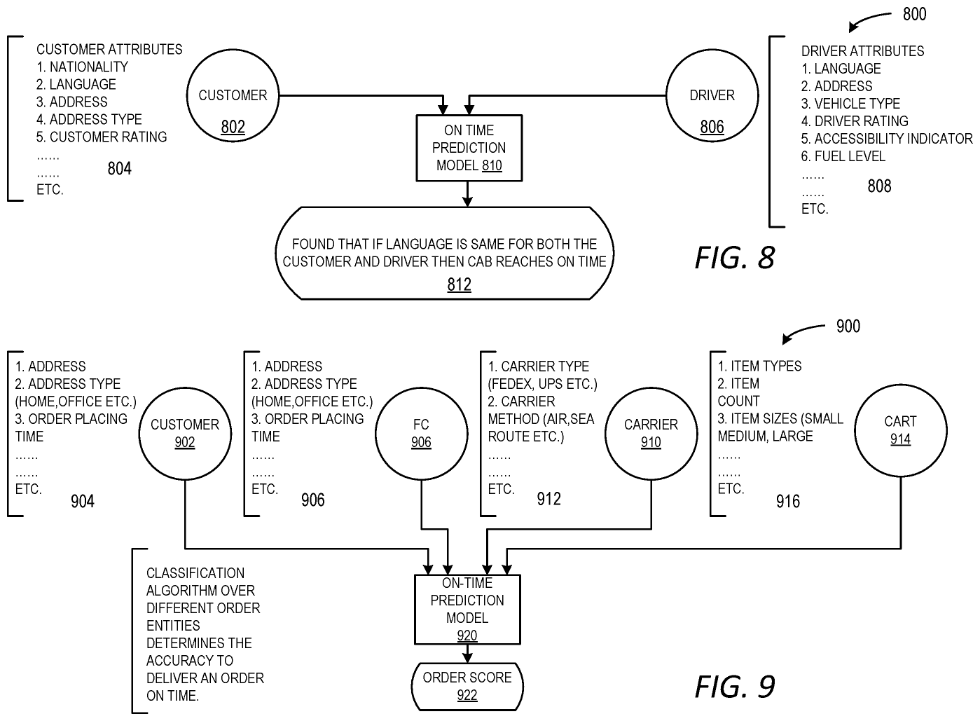

FIG. 8 is an exemplary flow diagram illustrating an example embodiment for on-time delivery prediction generation 800 in the ride sharing context. While FIG. 8 illustrates real-time ride sharing/ride sourcing, and real-time ride sharing/ride sourcing is discussed below, examples of the disclosure are configurable to apply to any form of ride sharing and/or ride sourcing, depending on the intended application. Real-time ride sharing (also referred to as instant ridesharing, dynamic ridesharing, ad-hoc ridesharing, on-demand ridesharing, and dynamic carpooling), describes any service that arranges one-time shared rides with minimal notice. Ride sourcing describes any service wherein drivers do not share a destination with their passengers—such services instead outsource rides to commercial drivers.

In the example embodiment presented by FIG. 8, a customer 802 has associated customer attributes 804, which include but are not limited to language, address, address type, and customer rating. A candidate driver 806 has associated candidate driver attributes 808, including but not limited to nationality, language, address, vehicle type, and candidate driver rating. In this scenario, predicting the likelihood that the candidate driver 806 arrives at the location of the customer 802 on-time (the “on-time success probability”) is contemplated by aspects of the disclosure herein in a similar manner as that of the goods and/or services order delivery context discussed elsewhere herein. In this example embodiment, to find the on-time arrival success probability, an on-time prediction model 810 obtains information about the customer 802, the customer attributes 804, the candidate driver 806, and the candidate driver attributes 808. The on-time prediction model 810 is a specialized example of an order-score component (e.g.: the order-score component 122 of FIG. 1) and/or methodology (e.g.: the methodology of calculating order-scores in FIG. 3) whose elements, including machine learning elements, inputs, and outputs, have been customized not to make delivery predictions regarding orders for goods and/or services from providers, but instead to make on-time delivery predictions for the delivery of a driver and vehicle to a customer in need of transportation. and processes these inputs using a specifically tailored order-score generation methodology, as discussed elsewhere herein. In some examples, the on-time prediction model 810 recommends an attribute variable, such as for example that the language of the customer 802 and the language of the driver 806 be the same in order to improve an on-time arrival success probability. If the language of the candidate driver 806 does not match the language of the customer 802, the on-time prediction model 810 may suggest an attribute variable, or modification, to choose another candidate driver other than the candidate driver 806 as a possibility to meet the customer 802′s request at 812. In other examples, other combinations of customer attributes 804 and candidate driver attributes 808 are used, depending on the specific needs and requirements of the intended application.

In some examples, an accessibility indicator attribute (not shown) of the candidate driver 806 is included in the candidate driver attributes 808. The accessibility indicator attribute is used to indicate candidate drivers 806 having additional training and/or possessing vehicles that are specially configured to safely accommodate customers 802 with significant disabilities, such customers 802 requiring assistance to enter and/or exit a vehicle, and/or customers 802 having assistive devices (e.g.: walkers, wheelchairs, crutches, canes, etc.) requiring more in-vehicle storage space. Such an accessibility indicator would prevent candidate drivers 806 lacking such training and/or suitable vehicles from being chosen to pick up a disabled customer 802, even if the candidate driver 806 is otherwise the ideal choice. The accessibility indicator would thus decrease inconvenience and increase safety for both the candidate driver 806 and the customer 802.

In another example, a fuel level attribute of the candidate driver 806, based at least in part on sensor data (similar to the sensor data 192 of FIG. 1), is included in the candidate driver attributes 808. The fuel level attribute is used to indicate the current fuel level of the vehicle belonging to the candidate driver 806. The on-time prediction model 810 uses the fuel level attribute of the candidate driver 806 in combination with the destination attribute of the customer 802 to exclude candidate drivers 806 who have insufficient fuel to collect the customer 802 and to deliver the customer 802 to the destination address.

In the example embodiment presented by FIG. 9, a customer 902 has associated customer attributes 904, which include but are not limited to: address, address type (e.g.: home, office, etc.), order placement time, etc. A fulfillment center (“FC”) 906 has associated fulfillment center attributes 908, which include but are not limited to: FC type, FC location, FC rating, etc. A carrier 910 has associated carrier attributes 912, which include but are not limited to: carrier type (e.g.: FedEx, UPS, etc.), carrier method (e.g.: air, ground, standard speed, overnight, local, etc.). A cart 914 has associated cart attributes 916, which include but are not limited to item types, item count, item sizes (e.g.: small, medium, large), etc. In some examples, the cart 914 represents an order placed by the customer 902.

In this scenario, predicting the likelihood that the order represented by the cart 914 is delivered to the customer 902 on-time (the “on-time delivery success probability”) is contemplated by aspects of the disclosure herein in a similar manner as that of in the goods and/or services order delivery context discussed elsewhere herein (e.g.: in FIG. 1 and FIG. 3). In this case, to find the on-time delivery success probability an on-time prediction model 920 obtains information about the customer 902, the customer attributes 904, the fulfillment center 906, the fulfillment center attributes 908, the carrier, the carrier attributes 912, the cart, and the cart attributes 916. The on-time prediction model 920 processes these inputs using a specifically tailored methodology to generate an order-score 922, as discussed elsewhere herein. In some examples, the on-time prediction model 920 iterates over various fulfillment center attributes 908 and carrier attributes 912 to recommend changes that will improve an on-time delivery success probability score as represented by the order-score 922. For example, if the carrier 910 noticeably underperforms when delivering to the geographical area of the customer 902 as indicated by historical data or telemetry data, the on-time prediction model 920 rejects the carrier 910 and recommends the alternative carrier.

In another example embodiment (now shown), a customer has associated customer attributes which include but are not limited to: address, address type (e.g.: home, office, etc.), order placement time, pet ownership, etc. A vendor store has associated vendor store attributes, which include but are not limited to: VS type, VS location, VS rating, etc. An on-demand personal shopper (an “ODPC”) has associated ODPC attributes which include but are not limited to: vehicle type, vehicle temperature control equipment (e.g.: for perishables that must be kept cold or hot) available vehicle storage space, geographical coverage area, available delivery methods—guaranteed two-hour delivery, guaranteed twelve-hour delivery, guaranteed twenty-four hour delivery, willingness to deliver to customers owning pets, etc. A cart has associated cart attributes, which include but are not limited to item types, item count, item sizes (e.g.: small, medium, large), item location (e.g.: a specific store), etc. In some examples, the cart represents an order placed by the customer for on-demand fulfillment and delivery by a personal shopper.

In this scenario, predicting the likelihood that the order represented by the cart is delivered to the customer within the requested on-demand time frame (the “on-time delivery success probability”) is contemplated by aspects of the disclosure herein in a similar manner as that of in the goods and/or services order delivery context discussed elsewhere herein (e.g.: in FIG. 1 and FIG. 3). In this case, to find the on-time delivery success probability an on-time prediction model obtains information about the customer, the customer attributes, the vendor store, the vendor store attributes, the ODPC, the ODPC attributes, the cart, and the cart attributes. The on-time prediction model processes these inputs using a specifically tailored methodology to generate an order-score, as discussed elsewhere herein. In some examples, the on-time prediction model iterates over various vendor store attributes and ODPC attributes to recommend changes that will improve an on-time delivery success probability score as represented by the order-score. For example, if the ODPC noticeably underperforms when delivering from a particular vendor store as indicated by historical data or telemetry data—e.g., because the ODPC is not yet familiar with efficiently navigating the vendor store and/or lacks subject-matter expertise in the vendor store's products—the on-time prediction model rejects the ODPC and recommends the alternative ODPC. As another example, if the ODPC has indicated an unwillingness to deliver to customers indicating pet ownership (e.g.: out of fear of large dogs), the on-time prediction model rejects the ODPC and recommends the alternative ODPC, who affirmatively indicated a willingness to deliver to customers having pets.

FIG. 10 is an exemplary block diagram illustrating a machine learning component 1000. The machine learning component 1000 analyzes delivery prediction criteria 1002 using feedback 1004, training data 1006, user preferences 1008, historical transaction data 1010, and/or telemetry data 1012.

In some examples, the feedback 1004 includes but is not limited to delivery prediction generation accuracy feedback, feedback associated with the efficiency of the at least one order attribute variable chosen to mitigate low order-scores (based on the actual delivery date and actual delivery time of an order), and/or feedback associated with inaccurate order-scores. If the system accurately calculates an initial order-score for the obtained order based on the determined initial values for each order attribute in the plurality of order attributes, generates the at least one order attribute variable for the plurality of order attributes, and calculates an alternative order-score for the obtained order based on the determined initial values for each order attribute in the plurality of order attributes and the generated at least one order attribute variable, while exhibiting few or no inaccurate calculations of the initial order-score, the at least one order attribute variable, or the alternative order-score, the feedback may be good. If the system instead performs such operations inaccurately, the feedback may be poor.

In some examples, the feedback 1004 associated with inaccurate calculations is indicated by the user (e.g.: the user 128 in FIG. 1) interacting with a user interface (e.g. the user interface component 110 of the computing device 102 or the user interface component 120 of the user device 116 of FIG. 1) as discussed in more detail elsewhere within this disclosure.

In some examples, the user preferences 1008 include user-selected output preferences. In some such examples, the user preferences 1008 include user-selected colors for formatting display of the at least one order attribute variable depending on how effectively the at least one order attribute variable is predicted to improve the alternative order-score (e.g.: high improvement indicated by green text; moderate improvement indicated by yellow text; and no improvement indicated by red text). In another example, the user preferences 1008 specify delivery generation prediction optimizations to accommodate for conditions specific to a particular order obtained from the order management system (e.g.: the order management component 122 of FIG. 1) in order to generate the most accurate delivery predictions.

The machine learning component 1000 utilizes real-time data, such as the feedback 1004, to adjust weights associated with each of the delivery prediction criteria 1002. For example, if the delivery prediction criteria 1002 indicate the user prefers the most accurate delivery prediction even at the expense of delivery prediction speed, the delivery prediction criteria 1002 are weighted to indicate that accuracy should be prioritized over performance. In another example, if the delivery prediction criteria 1002 indicate the user wants the most accuracy in the generation of delivery predictions for orders for which purchasers have requested rush delivery, even at the expense of accuracy in delivery prediction of non-rush orders, the delivery prediction criteria 1002 are weighted to indicate that accuracy of delivery prediction generation for rush orders should have priority.

The machine learning component 1000 in some examples utilizes the feedback 1004 from the user, and the training data 1006, historical transaction data 1010, and telemetry data 1012 associated with delivery prediction generation to adjust the delivery prediction criteria 1002 weights. In the example above, if customers frequently place orders requesting rush delivery, the machine learning component 1000 generates weighted selection criteria 1014 indicating that the greatest preference should be given to attempting to generate the highest possible order-scores to ensure rush deliveries arrive on-time.

In some examples, the delivery prediction criteria 1002, the feedback 1004, the training data 1006, the user preferences 1008, the historical transaction data 1010, the telemetry data 1012, and/or the weighted selection criteria 1014 are stored in the set of machine learning inputs 190 within the data storage device 150 of the computing device 102 in FIG. 1.

In some examples, the machine learning component 1000 comprises a trained regressor such as a random decision forest, directed acyclic graph, support vector machine, neural network, or other trained regressor. The trained regressor may be trained using the feedback 1004 described above. Examples of trained regressors include a convolutional neural network and a random decision forest. It should further be understood that the machine learning component 1000, in some examples, operates according to machine learning principles and/or techniques known in the art without departing from the systems and/or methods described herein.

### ADDITIONAL EXAMPLES

Contemporary order management systems merely aim to predict the time taken for the delivery to be completed based upon the average carrier performance and fail to give due weight to outliers in historical data and telemetry data. The disclosure herein instead utilizes the order-score to predict the accuracy of time predicting services, in part by predictively finding common repeating outliers and eliminating such combinations from order transactions. The order-score makes such predictions by awareness and manipulation of deterministic synergy. Various factors (e.g.: order attributes) are involved in the placement and fulfillment of an order from a customer by a provider. In some examples, any single factor individually has no negative impact upon successful completion of an on-time delivery and/or the probability of on-time delivery. However, in some examples, such individual factors, in combination with other factors, create bottlenecks deterministic to the delivery time and/or the probability of successful on-time delivery.

For example, obtained sensor data corresponding to one or more of the order attributes may indicate a condition that affects the weight of the order attribute in an order score calculation for that order. As one illustrative example, sensor data that includes weather data related to a delivery address may be used to determine an impact for on-time delivery to that address in current conditions. In other examples, the sensor data may be used in combination with telemetry data to calculate the initial values for the order attributes, using machine learning techniques to refine the weighting or impact of real-time conditions for each order attribute.

Given the foregoing, while the disclosure herein primarily features examples of using the order-score in conjunction with deliveries of goods and/or services from providers to customers, the order-score based methods and systems described herein are equally applicable to any application using predictive calculations to optimize choices. Such optimization is accomplished by: (1) identifying, through continuous feedback, negative factors which increase the likelihood that predictive systems fail to predict accurate estimated arrival times; and (2) maximizing the probability of correctly predicting such estimated arrival times, while incurring only a marginal increase in costs, to break the chain of factors that otherwise lead to a failed transaction or missed prediction of on-time delivery.

In some examples, the training data used by the machine learning component (e.g.: the training data 1006 of the machine learning component 1000 of FIG. 10) is pre-processed such that it is in an optimal format for use by the machine learning component 1000.

In some examples, the goal of the order-score component in indicating the at least one order attribute variable is to use patterns found among the common repeating outliers which are known to decrease the probability of on-time delivery and instruct the order management component how to change the corresponding at least one order attribute to break the pattern and create the largest improvement in the probability of on-time delivery with the least cost. In some such examples, the order-score component indicates a single order attribute variable, such that using the single order attribute variable to change the corresponding order attribute represents the best option for increasing the order-score out of all the possible single order attribute changes.

In some examples, the plurality of order attributes is created by a module other than the order management component, and then output from that module to the order management component to become part of the order obtained by the order-score component.

Electronic commerce (also referred to herein as “e-commerce” or “eCommerce” is either a component of a business model or entire business model enabling a provider to conduct business with customers over a communications network (e.g.: the internet). Electronic commerce is applicable to all major transaction types: business to business, business to consumer, consumer to consumer, and consumer to business. Almost every product or service is transactable via e-commerce (e.g.: books, music, financial services, plane tickets, etc.). Some examples of the disclosure herein are especially optimized for and intended for use in e-commerce.

The disclosure herein is applicable to examples involving professional parcel carriers (e.g.: UPS®, FEDEX®, the United States Postal Service, DHL®, etc.), as well as crowdsourced delivery services. Crowdsourced delivery, alternatively referred to as crowdsourced shipping, is a method of delivery fulfillment that leverages networks of local, non-professional couriers to deliver packages to complete deliveries. Common applications for crowdsourced deliveries include meal and grocery delivery. Crowdsourced delivery services are attractive in any scenario where a provider wishes to cut costs while maximizing supply chain efficiency. As in the ride sharing/ride sourcing examples discussed elsewhere herein, the individual delivery person becomes an order attribute when applying the order-score system and methodology to crowdsourced delivery services.

Some examples herein are described as performing certain operations via “iteration,” “iterative computing,” and other variations of such language. Iteration refers to repeatedly performing the same operation or set of operations upon each object in a set of objects until the operation or set of operations has been performed upon every object in the set of objects. It should be understood that, unless explicitly stated otherwise, iteration over a set of objects is practicable either sequentially (e.g.: operate on A; then B; then C; then D) or concurrently (e.g.: operate on A and B simultaneously; then operate on C and D simultaneously). Some examples of concurrent iteration process as many objects at once as an example operating environment practicably allows.

Sequential iteration is most suitable to examples where only a single processor (such as processor 106) is available to perform operations and/or the computing environment (e.g.: the computing device 102) does not support multi-threaded computation. Concurrent iteration is most suitable to examples where more than one processor (such as processor 106) is available to perform operations and/or the computing environment does support multi-threaded (also referred to as parallel) computation. Concurrent iteration exhibits considerable performance advantages over sequential iteration, especially when working with large data sets.

Examples are given herein, in both this Detailed Description and the Drawings, utilizing sequential iteration so that the Detailed Description and Drawings facilitate both full understanding of the disclosure and the greatest possible clarity. No portion of this disclosure expresses, nor is any portion of this disclosure intended to express, that only sequential iteration or concurrent iteration is usable for any particular instance of iteration herein. The use of sequential iteration in the Drawings does not express a preference for sequential iteration over concurrent iteration. No such preference exists—examples of the disclosure should implement whatever type of iteration is most suited to the example's intended application.

Push Architecture vs. Pull Architecture. In some examples utilizing a pull architecture (also referred to as a “fetch architecture”), the order-score component continuously requests new orders from the order management component. The order-score component makes such requests once per given unit time (e.g.: once every minute). The order-score component operates on the orders obtained from such requests. In some examples utilizing a push architecture, after the order management component creates a new order, the order management component initiates communication with the order-score component (e.g.: by application programming interface call or order polling system) to deliver the order to the order-score component. Thus, the order-score component is not continuously requesting new orders as in a fetch architecture, but instead continuously listening for new orders to arrive. Whether pull architecture, push architecture, or some combination of both is in use to communicatively connect the order management component to the order-score component makes no difference in how the order-score component operates on the obtained orders.

In some examples, when the order-score system outputs the initial order-score and the alternative order-score of the order, with an indication of the at least one order attribute variable, to the order management component, the order-score system only delivers a single order attribute variable, representing the best choice to cause the alternative order-score to increase as much as possible over the initial order-score, optionally based at least in part on historical data and/or telemetry data interpreted by the ML elements of the order-score component.

In some examples, the order management component determines whether to make any changes to how the order delivery method based on the initial order-score and alternative order-score. In some examples, the decision of the order management component is binary: to either adopt the change to the order attributes indicated by the order management component or do nothing.

Alternatively, or in addition to the other examples described herein, examples include any combination of the following:
iteratively compute a plurality of order attribute variables for the plurality of order attributes to generate the at least one order attribute variable, the generated at least one order attribute variable determined to increase the alternative order-score relative to the initial order-score;
the order-score component iteratively computes the plurality of order attribute variables based at least in part on historical data associated with past orders;
the order-score component iteratively computes the plurality of order attribute variables based at least in part on telemetry data associated with past alternative order-scores and generated order attribute variables;
the plurality of order attributes includes at least one of a postal code of a delivery address, a weight of at least one item of the order, a height of at least one item of the order, a length of at least one item of the order, a width of at least one item of the order, a quantity of items associated with the order, an associated distribution center value for the order, an associated fulfillment center value for the order, a time in transit value for the order, a customer type, a delivery address type, a date of order placement for the order, a time of order placement for the order, an expected shipping date for the order, or a carrier selection associated with the order;
receive an order change instruction for the order from the order management component;
analyze the order change instruction to identify one or more order attribute deltas from the plurality of order attributes;
determine an initial value for each of the identified one or more order attribute deltas;
calculate an updated order-score for the obtained order based on the determined initial values for each order attribute in the plurality of order attributes and the initial values for each of the identified one or more order attribute deltas; and/or
the initial order-score and the alternative order-score are individual predictions of whether the order will be delivered on time.

At least a portion of the functionality of the various elements in FIG. 1, FIG. 2, and FIG. 10 may be performed by other elements in FIG. 1, FIG. 2, and FIG. 10, or an entity (e.g., processor 106, web service, server, application program, computing device, etc.) not shown in FIG. 1, FIG. 2 and FIG. 10.

In some examples, the operations illustrated in FIG. 3, FIG. 4, and FIG. 5 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

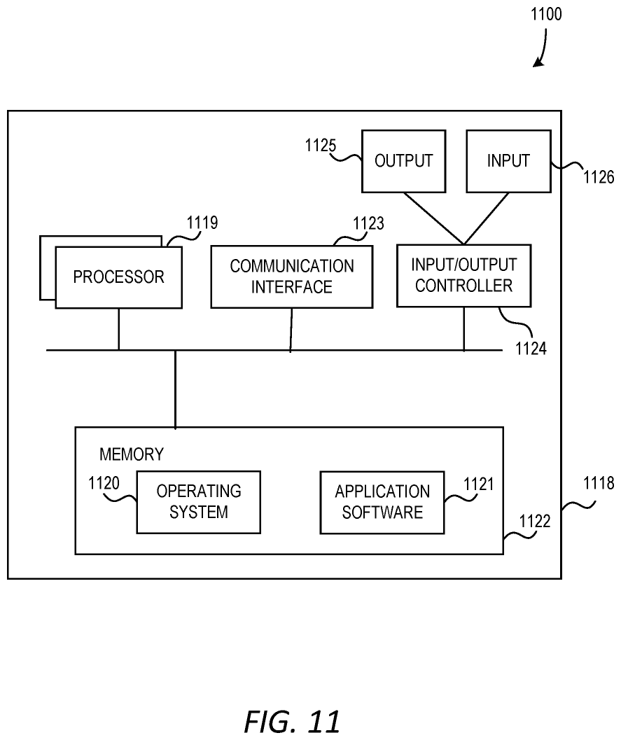

The present disclosure is operable with a computing apparatus according to an embodiment as a functional block diagram 1100 in FIG. 11. In an embodiment, components of a computing apparatus 1118 may be implemented as a part of an electronic device according to one or more embodiments described in this specification. The computing apparatus 1118 comprises one or more processors 1119 which may be microprocessors, controllers or any other suitable type of processors for processing computer executable instructions to control the operation of the electronic device. Platform software comprising an operating system 1120 or any other suitable platform software may be provided on the computing apparatus 1118 to enable application software 1121 to be executed on the device. According to an embodiment, delivery prediction generation as described herein may be accomplished by software.

Computer executable instructions may be provided using any computer-readable media that are accessible by the computing apparatus 1118. Computer-readable media may include, for example, computer storage media such as a memory 1122 and communications media. Computer storage media, such as a memory 1122, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1122) is shown within the computing apparatus 1118, it will be appreciated by a person skilled in the art, that the storage may be distributed or located remotely and accessed via a network or other communication link (e.g. using a communication interface 1123).

The computing apparatus 1118 may comprise an input/output controller 1124 configured to output information to one or more output devices 1125, for example a display or a speaker, which may be separate from or integral to the electronic device. The input/output controller 1124 may also be configured to receive and process an input from one or more input devices 1126, for example, a keyboard, a microphone or a touchpad. In one embodiment, the output device 1125 may also act as the input device 1126. An example of such a device may be a touch sensitive display. The input/output controller 1124 may also output data to devices other than the output device, e.g. a locally connected printing device. In some embodiments, a user may provide input to the input device(s) 1126 and/or receive output from the output device(s) 1125.

The functionality described herein can be performed, at least in part, by one or more hardware logic components. According to an embodiment, the computing apparatus 1118 is configured by the program code when executed by the one or more processors 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (AS SPs), System-on-a-chip systems (SOCs), Complex Programmable Logic Devices (CPLDs), Graphics Processing Units (GPUs).

Although described in connection with an exemplary computing system environment, examples of the disclosure are capable of implementation with numerous other general-purpose or special-purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for delivery prediction generation. For example, the elements illustrated in FIG. 1, FIG. 2, and FIG. 10, such as when encoded to perform the operations illustrated in FIG. 3, FIG. 4, and FIG. 5 constitute exemplary means for generating delivery predictions for virtual orders implemented on at least one processor, comprising: obtaining, by an order-score component implemented on the at least one processor, an order from an order management component; analyzing the obtained order to identify a plurality of order attributes; obtaining sensor data corresponding to at least one identified order attribute in the plurality of order attributes; determining an initial value for each order attribute in the plurality of order attributes based at least in part on the obtained sensor data and at least in part on telemetry data; calculating an initial order-score for the obtained order based on the determined initial values for each order attribute in the plurality of order attributes; generating at least one order attribute variable for the plurality of order attributes; calculating an updated value for the at least one order attribute variable; calculating an alternative order-score for the obtained order based on the determined initial values for each order attribute in the plurality of order attributes and the calculated updated value for the generated at least one order attribute variable; and outputting the initial order-score and the alternative order-score for the obtained order, with an indication of the at least one order attribute variable associated with the alternative order-score, to the order management component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor;
a memory communicatively coupled to the processor; and
an order-score component including a machine learning element, the order-score component stored on the memory and executed by the processor to:
obtain an order;
analyze the order to identify a plurality of order attributes;
obtain sensor data corresponding to each order attribute in the plurality of order attributes;
determine an initial value for each order attribute in the plurality of order attributes based at least in part on the sensor data and at least in part on telemetry data;
calculate an initial order-score for the order based on the initial values for each order attribute in the plurality of order attributes;
generate an order attribute variable for the order;
calculate an updated value for the order attribute variable;
calculate an alternative order-score for the order based on the initial values for each order attribute in the plurality of order attributes and the updated value for the order attribute variable;
output the initial order-score and the alternative order-score for the order, with an indication of the order attribute variable associated with the alternative order-score;
receive feedback data corresponding to the order; and
adjust a set of prediction criteria of the machine learning element based on the feedback data.

2. The system of claim 1, wherein the telemetry data includes historical data and historical feedback data associated with past orders.

3. The system of claim 1, wherein generating the order attribute variable for the order comprises: iteratively computing a plurality of candidate order attribute variables to determine the order attribute variable, wherein the order attribute variable is determined to generate the alternative order-score higher than the initial order-score.

4. The system of claim 1, wherein an initial probability is associated with the initial order-score and an alternative probability is associated with the alternative order-score, and wherein the alternative probability is a higher probability of on-time delivery than the initial probability.

5. The system of claim 4, wherein the order-score component is further executed by the processor to:
determine an additional cost associated with the order attribute variable; and
perform a cost-benefit analysis comparing the additional cost to benefit indicated by the higher probability of on-time delivery.

6. The system of claim 5, wherein the cost-benefit analysis comprises comparing the additional cost to a threshold.

7. The system of claim 1, wherein the feedback data includes at least one of delivery prediction generation accuracy feedback, feedback associated with efficiency of the order attribute variable, or feedback associated with inaccurate order-scores.

8. A method comprising:
obtaining an order;
analyzing, using a machine learning element, the order to identify a plurality of order attributes;
obtaining sensor data corresponding to each order attribute in the plurality of order attributes;
determining, by the machine learning element, an initial value for each order attribute in the plurality of order attributes based at least in part on the sensor data and at least in part on telemetry data;
calculating, by the machine learning element, an initial order-score for the order based on the initial values for each order attribute in the plurality of order attributes;
generating an order attribute variable for the order;
calculating, by the machine learning element, an updated value for the order attribute variable;
calculating, by the machine learning element, an alternative order-score for the order based on the initial values for each order attribute in the plurality of order attributes and the updated value for the order attribute variable;
outputting the initial order-score and the alternative order-score for the order, with an indication of the order attribute variable associated with the alternative order-score;
receiving feedback data corresponding to the order; and
adjusting a set of prediction criteria of the machine learning element based on the feedback data.

9. The method of claim 8, wherein the telemetry data includes historical data and historical feedback data associated with past orders.

10. The method of claim 8, wherein generating the order attribute variable for the order comprises: iteratively computing a plurality of candidate order attribute variables to determine the order attribute variable, wherein the order attribute variable is determined to generate the alternative order-score higher than the initial order-score.

11. The method of claim 8, wherein an initial probability is associated with the initial order-score and an alternative probability is associated with the alternative order-score, and wherein the alternative probability is a higher probability of on-time delivery than the initial probability.

12. The method of claim 11, further comprising:
determining an additional cost associated with the order attribute variable; and
performing a cost-benefit analysis comparing the additional cost to benefit indicated by the higher probability of on-time delivery.

13. The method of claim 12, wherein the cost-benefit analysis comprises comparing the additional cost to a threshold.

14. The method of claim 8, wherein the feedback data includes at least one of delivery prediction generation accuracy feedback, feedback associated with efficiency of the order attribute variable, or feedback associated with inaccurate order-scores.

15. One or more computer storage media having computer-executable instructions stored thereon that, when executed by a computer, cause the computer to perform operations comprising:
obtaining an order;
analyzing, using a machine learning element, the order to identify a plurality of order attributes;
obtaining sensor data corresponding to each order attribute in the plurality of order attributes;
determining, by the machine learning element, an initial value for each order attribute in the plurality of order attributes based at least in part on the sensor data and at least in part on telemetry data;
calculating, by the machine learning element, an initial order-score for the order based on the initial values for each order attribute in the plurality of order attributes;
generating an order attribute variable for the order;
calculating, by the machine learning element, an updated value for the order attribute variable;
calculating, by the machine learning element, an alternative order-score for the order based on the initial values for each order attribute in the plurality of order attributes and the updated value for the order attribute variable;
outputting the initial order-score and the alternative order-score for the order, with an indication of the order attribute variable associated with the alternative order-score;
receiving feedback data corresponding to the order; and
adjusting a set of prediction criteria of the machine learning element based on the feedback data.

16. The one or more computer storage media of claim 15, wherein the telemetry data includes historical data and historical feedback data associated with past orders.

17. The one or more computer storage media of claim 15, wherein generating the order attribute variable for the order comprises: iteratively computing a plurality of candidate order attribute variables to determine the order attribute variable, wherein the order attribute variable is determined to generate the alternative order-score higher than the initial order-score.

18. The one or more computer storage media of claim 15, wherein an initial probability is associated with the initial order-score and an alternative probability is associated with the alternative order-score, and wherein the alternative probability is a higher probability of on-time delivery than the initial probability.

19. The one or more computer storage media of claim 18, wherein the operations further comprise:
determining an additional cost associated with the order attribute variable;
performing a cost-benefit analysis comparing the additional cost to benefit indicated by the higher probability of on-time delivery; and
comparing the additional cost to a threshold.

20. The one or more computer storage media of claim 15, wherein the feedback data includes at least one of delivery prediction generation accuracy feedback, feedback associated with efficiency of the order attribute variable, or feedback associated with inaccurate order-scores.
